(19) United States
(12) Patent Application Publication
(10) Pub. No.: US 2020/0387892 A1
(43) Pub. Date: Dec. 10, 2020

(54) SYSTEMS AND METHODS FOR TEMPORARY ACCOUNT SHARING VIA A MOBILE WALLET

(71) Applicant: Wells Fargo Bank, N.A., San Francisco, CA (US)

(72) Inventors: Azita Asefi, Vacaville, CA (US); Marcia Klingensmith, Pleasant Hill, CA (US); Joon Maeng, San Francisco, CA (US); Jenny Y. Tao, Belmont, CA (US); Michael R. Thomas, San Francisco, CA (US)

(21) Appl. No.: 15/624,110

(22) Filed: Jun. 15, 2017

(51) Int. Cl. G06Q 20/36

(52) U.S. Cl. CPC G06Q 20/3674

(57) ABSTRACT

A mobile wallet computing system includes a processing circuit configured to receive an approval request for a prospective mobile wallet transaction from a first device associated with the purchaser, the approval request identifying the approver and including a characteristic of the prospective mobile wallet transaction, transmit a transaction notification to a second device associated with the approver, the transaction notification including the characteristic of the prospective transaction, receive an approval input from the second device, the approval input identifying a payment account of the approver that is not provisioned to the first mobile wallet account, and transmit a set of payment credentials associated with the payment account to the first device.

### BACKGROUND

Payments for products and services are often completed using credit cards, debit cards, checks, or cash. Generally, when completing a card transaction (e.g., debit card, credit card, gift card, etc.) at a brick-and-mortar merchant location, a person first locates a wallet, identifies which card from a plurality of cards to use for the purchase, swipes the card at a point of sale (“POS”) terminal, and signs for the transaction. At the same time, most people carry some type of mobile handheld electronic device, such as a cellular phone, smart phone, mobile handheld wireless e-mail device, personal digital assistant, portable gaming devices, and so on. Many of these devices have a wireless Internet connection.

A person may wish to make payments to merchants using these mobile devices. In some instances, a person may wish to make such payments using an account that the person does not own or otherwise have access to. For example, a child may wish to make a purchase with a parent's account. Further, such a child may wish to make a purchase with the parent not being physically present at the point of purchase. Accordingly, enhanced systems and methods of facilitating such transactions using mobile devices would be desirable.

### SUMMARY

One embodiment relates to a computer-implemented method. The method includes receiving, by a mobile wallet computing system, an approval request for a prospective mobile wallet transaction from a first device associated with a purchaser, the approval request identifying an approver and including a characteristic of the prospective mobile wallet transaction. The method also includes transmitting, by the mobile wallet computing system, a transaction notification to a second device associated with the approver, the transaction notification including the characteristic of the prospective transaction. The method also includes receiving, by the mobile wallet computing system, an approval input from the second device, the approval input identifying a payment account of the approver that is not provisioned to the purchaser's mobile wallet. The method also includes transmitting, by the mobile wallet computing system, a set of payment credentials associated with the payment account to the first device.

Another embodiment relates to a mobile wallet computing system. The mobile wallet computing system includes a network interface configured to communicate data over a network. The mobile wallet computing system also includes a mobile wallet database configured to store information regarding a first mobile wallet account associated with a purchaser and a second mobile wallet account associated with an approver. The mobile wallet computing system also includes a processing circuit. The processing circuit is configured to receive, by the network interface, an approval request for a prospective mobile wallet transaction from a first device associated with the purchaser, the approval request identifying the approver and including a characteristic of the prospective mobile wallet transaction. The processing circuit is also configured to transmit, by the network interface, a transaction notification to a second device associated with the approver, the transaction notification including the characteristic of the prospective transaction. The processing circuit is also configured to receive, by the network interface, an approval input from the second device, the approval input identifying a payment account of the approver that is not provisioned to the first mobile wallet account. The processing circuit is also configured to transmit, by the network interface, a set of payment credentials associated with the payment account to the first device.

Another embodiment relates to a non-transitory computer readable media having computer-executable instructions embodied therein that, when executed by a processor of a mobile wallet computing system, cause the mobile wallet computing system to perform operations to enable a payment. The operations include receiving an approval request for a prospective mobile wallet transaction from a first device associated with a purchaser, the approval request identifying an approver and including a characteristic of the prospective mobile wallet transaction. The operations also include transmitting a transaction notification to a second device associated with the approver, the transaction notification including the characteristic of the prospective transaction. The operations also include receiving an approval input from the second device, the approval input identifying a payment account of the approver that is not provisioned to the purchaser's mobile wallet. The operations also include transmitting a set of payment credentials associated with the payment account to the first device.

These and other features, together with the organization and manner of operation thereof, will become apparent from the following detailed description when taken in conjunction with the accompanying drawings.

### BRIEF DESCRIPTION OF THE DRAWINGS

FIG. 1 is a block diagram of a computing environment, according to an example embodiment.

FIG. 2 is an example communications interface presented to an approver of a remote mobile wallet transaction, according to an example embodiment.

FIG. 3 is an example communications interface presented to a purchaser, according to an example embodiment.

FIG. 4 is a flow diagram of a method of making a payment at a merchant, according to an example embodiment.

FIG. 5 is a flow diagram of an alternative method of making a payment at a merchant, according to an example embodiment.

### DETAILED DESCRIPTION

Before turning to the figures which illustrate example embodiments, it should be understood that the application is not limited to the details or methodology set forth in the following description or illustrated in the figures. It should also be understood that the phraseology and terminology employed herein is for the purpose of description only and should not be regarded as limiting.

Referring generally to the figures, systems and methods for enabling a first mobile wallet user (herein called the “approver”) to approve a transaction and provide payment credentials to a second user (herein called the “purchaser”) to complete the transaction are described. For example, a purchaser may seek to purchase a product at a merchant. To do this, the purchaser may provide an input to a first mobile wallet on a first device that identifies the approver and also input a transaction message describing the product. In turn, the first device may transmit the message to a mobile wallet computing system over a network, which may identify a second device associated with the approver and transmit the message to the second device. The approver may view the message via a second mobile wallet, approve the purchase, and select a payment account to be used to make a payment to the merchant. Upon the approver's selection of the payment account, a set of payment credentials associated with the selected payment account may be transmitted to the first device. The first device then relays the set of payment credentials to a merchant point of sale (POS device) to facilitate payment for the purchase. In various embodiments, the set of payment credentials is not stored on the first device, but rather “pass through” the first device to the POS device. This way, the approver maintains control over where the set of payment credentials are stored.

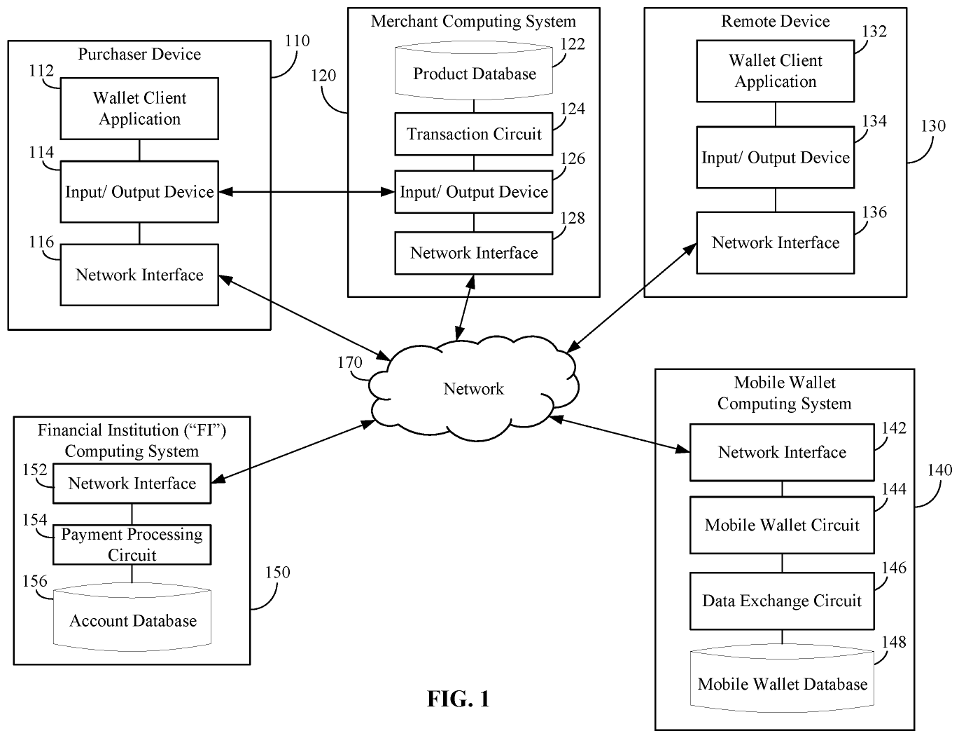

Referring to FIG. 1, a diagram of a computing environment 100 is shown, according to an example embodiment. The computing environment 100 facilitates the completion of a purchase at a merchant by a purchaser via a purchaser device 110 using payment credentials that are not stored at the purchaser device 110. The environment 100 includes the purchaser device 110, a merchant computing system 120, a remote device 130, a mobile wallet computing system 140, and a financial institution computing system 150, whereby all such elements may be communicably coupled with one another via a network 170. The network 170 may include wireless networks (e.g., cellular networks, Bluetooth®, WiFi, Zigbee®, etc.), wired networks (e.g., Ethernet, DSL, cable, fiber-based, etc.), or a combination thereof. In some arrangements, the network 170 includes the internet.

In the example shown, the financial institution computing system 150 is a computing system associated with a financial institution that provides and maintains one or more financial accounts (e.g., demand deposit account, credit or debit card account, brokerage account, etc.) on behalf of the approver. In the context of the present disclosure, the financial institution can include commercial or private banks, credit unions, investment brokerages, mobile wallet providers, and so on. Additionally, the financial institution can also include any commercial entity capable of maintaining payment accounts on behalf of a user, including retailers, vendors, service providers, and the like. In some arrangements, the financial institution is also a mobile wallet provider configured to manage mobile wallet accounts on behalf of its customers (i.e., users), including authenticating mobile wallet transactions involving debits from the users' payment accounts. For example, the financial institution may also operate the mobile wallet computing system 140 described below in various embodiments.

The financial institution computing system 150 includes a network interface 152 enabling the financial institution computing system 150 to exchange data over the network 170, a payment processing circuit 154, and an account database 156. The account database 156 is structured to retrievably store information pertaining to a plurality of financial accounts. The account database 156 may include non-transient data storage mediums (e.g., local disc or flash-based hard drives, local network servers, and the like) or remote data storage facilities (e.g., cloud servers). The account database 156 may include personal information (e.g., names, addresses, phone numbers, and so on), authentication information (e.g., username/password combinations, device authentication tokens, security question answers, unique customer identifiers, biometric data, etc.), and financial information (e.g., token information, account numbers, account balances, available credit, credit history, transaction histories, and so on) relating to the various users and associated financial accounts.

The payment processing circuit 154 is structured to process requests for transactions of various users (e.g., the approver and/or purchaser) holding accounts maintained at the account database 158. Through a process described below, for example, the purchaser may seek to make a purchase using an account held by the approver at the financial institution. As a result, the payment processing circuit 154 may receive an approval request originating from the merchant computing system 120 requesting the financial institution to approve the debiting of a transaction amount from the approver's account. For example, in some situations, the approval request may be provided to the financial institution computing system 150 via a card network computing system (e.g., Visa® or Mastercard®) configured to route payment requests from merchants to the financial institution. In response, the payment processing circuit 154 may perform various checks on the approver's account (e.g., if the account has sufficient funds) and, assuming these checks are met, transmit an approval over the network 170 that is eventually received by the merchant computing system 120. Additionally, the payment processing circuit 154 may deduct the transaction amount from the approver's account and provide the amount to an account associated with the merchant (e.g., at an acquiring financial institution).

The mobile wallet computing system 140 is structured to permit, enable, facilitate, manage, process, and otherwise allow mobile wallet transactions. The mobile wallet computing system 140 may be associated with, owned by, and/or otherwise operated by a mobile wallet provider. In some embodiments, the mobile wallet provider is an external entity (e.g., Apple®, Samsung®, or Google®) that provides a mobile wallet platform through which users can make various payments via various devices (e.g., similar to the purchaser device 110). In one embodiment, the mobile wallet provider may be a financial institution or affiliated with a financial institution, such as the financial institution associated with the financial institution computing system 150. In this instance, the mobile wallet computing system 140 may be a part of the financial institution computing system 150. In another embodiment and as shown, the mobile wallet provider may be a third party provider relative to the financial institution that operates the financial institution computing system 150.

In some embodiments, the mobile wallet computing system 140 may be separate from the financial institution computing system 150, yet associated with the same entity. To illustrate, in one embodiment, the financial institution is an issuer of a payment card associated with the approver, who has provisioned the payment card to the approver's mobile wallet. Additionally, in this embodiment, the financial institution also provides the wallet client application 132 onto the remote device 130 via the mobile wallet computing system 140. As such, the mobile wallet computing system 140 and the financial institution computing system 150 may be associated with the same or different entities and be embodied within the same system or in different systems in accordance with the present disclosure.

In any configuration, the mobile wallet computer system 140 may provide or at least partly provide a mobile wallet circuit 144. As described in more detail herein, the “mobile wallet” is a digital wallet provided on the purchaser device 110 and/or remote device 130. The digital wallet may include payment capabilities, such as the ability to use a communication protocol (e.g., near-field communication) at a point-of-sale terminal to transfer payment information and enable the purchase of a good or service. Additionally, the digital wallet may include many other capabilities, functions, and features that are described herein in more detail.

The mobile wallet computing system 140 is shown to include a network interface 142 enabling the mobile wallet computing system 140 to exchange data over the network 170, a mobile wallet circuit 144, a data exchange circuit 146, and a mobile wallet database 148. As described herein, the mobile wallet computing system 140 may be configured to exchange data with the purchaser device 110, the remote device 130, the merchant computing system 120, and the financial institution computing system 150 in the implementation of a purchaser mobile wallet on the purchaser device 110 and an approver mobile wallet on the remote device 130.

The mobile wallet database 148 is structured to retrievably store information pertaining to various mobile wallets (e.g., the approver's mobile wallet and the purchaser's mobile wallet). The mobile wallet database 148 may include non-transient data storage mediums (e.g., local disc or flash-based hard drives, local network servers, and the like) or remote data storage facilities (e.g., cloud servers). The mobile wallet database 148 may include information pertaining to various payment accounts that have been provisioned to various mobile wallets via the methods described below. The stored mobile wallet account information may include authentication information (e.g., username/password combinations, device authentication tokens, security question answers, etc.), payment card information (e.g., account numbers, expiration dates, etc.), and transaction history, account holder identifying information, registered device information, and any other information that may be encountered in the operation of a mobile wallet account or otherwise referenced herein. Such information may include user preferences and other information comprising a user profile.

In some arrangements, for example, mobile wallet database 148 also includes a token vault that is maintained by the mobile wallet computing system 140. The token vault may include a lookup table maintaining tokens associated with various user payment accounts. The tokens stored therein may be generated internally (e.g., at the mobile wallet computing system 140) or by other entities (e.g., at a card network computing system or the financial institution computing system 150). For example, in one embodiment, the token vault may include a lookup table including tokens that that have been randomly assigned to a user payment account (e.g., user lines of credit, user checking accounts, and the like) by the mobile wallet computing system 140. In some arrangements, the mobile wallet computing system 140 may include an associated token management system (not shown) including one or more algorithms, processes, formulas, etc. that facilitate the efficient searching of the information stored in the token vault. For example, a mapping algorithm may be utilized to map Token-to-Primary Account Number (PAN) information. Thus, when a token is received (e.g., from the merchant computing system 120), the mapping algorithm determines the associated PAN and sends that information to the issuer (e.g., the financial institution computing system 150).

The mobile wallet circuit 144 is structured to provide mobile wallets on the purchaser device 110 and remote device 130. In some embodiments, the mobile wallet circuit 144 is structured to provide wallet client applications (e.g., wallet client application 112 and wallet client application 132) on the purchaser device 110 and/or remote device 130. In this regard, the mobile wallet circuit 144 enables registrations of the purchaser and approver for mobile wallets and enables transactions using the mobile wallets by the methods disclosed herein.

With regard to registration for a mobile wallet, a prospective mobile wallet user (e.g., the purchaser and/or approver) may request the mobile wallet provider to register for a mobile wallet account. For example, via a web browser on a user computing device (such as the purchaser device 110 or remote device 130), the prospective user may visit a website associated with the mobile wallet provider and provide an input (e.g., select a registration button or the like) to the mobile wallet circuit 144 to register for a mobile wallet. In response, the mobile wallet circuit 144 may present the prospective user with various registration interfaces requesting various forms of information from the prospective user (e.g., user identification information, login credentials, payment account information, and the like) to establish a mobile wallet account to be maintained at the mobile wallet database 148. In some embodiments, where, for example, mobile wallet computing system 140 is associated with or a part of the financial institution computing system 150, such information may also be retrieved from an account database 158 at the financial institution computing system 150. Additionally, a software package similar to the wallet client applications 112 and 132 discussed below may be transmitted to the user computing device. The software package may include program logic that is hard coded into the memory of the user computing device and executable by the processor to perform any of the functions described herein.

In an example with the approver, once the wallet client application 132 is installed on the remote device 130, the approver can provide payment account information associated with various financial institutions to include in the approver's mobile wallet account. For example, the user may enter various payment credentials (e.g., PANs, verification codes, expiration dates, billing addresses, and the like) associated with various payment accounts held by the approver by manually inputting such information into the remote device 130 and/or taking pictures of payment cards (e.g., a debit card, credit card, or the like) associated with the payment accounts. Alternatively or additionally, the mobile wallet circuit 144 may retrieve such information from the account database 158 at the financial institution computing system 150 to automatically populate the user's wallet.

In any event, after such information is received, the mobile wallet circuit 144 may perform a process to generate payment tokens for each of the payment accounts regarding which information was received. For example, based on the payment credentials received from the approver and/or financial institution computing system 150, the mobile wallet circuit 144 may identify a card network or financial institution associated with each account and transmit requests to each of the identified entities to generate a token for the accounts. Once the tokens are generated, they are transmitted back to the mobile wallet computing system 140 and stored in association with the approver's mobile wallet account in the mobile wallet database 148. In some embodiments, once such a tokenization process occurs, the approver's mobile wallet is populated with the various payment accounts. For example, the mobile wallet circuit 144 may transmit the tokens to the remote device 130 for storage on the remote device 130 (e.g., in a secure element of the remote device 130) as well as other account identifying information (e.g., a portion of the PAN). In response, the wallet client application 132 may update the displays presented to the approver to incorporate representations of the approver's payment accounts and enable the user to provide an input to perform a POS transaction using a selected payment account.

According to the systems and methods disclosed herein, once the approver's mobile wallet is populated with various approver payment accounts, such payment accounts may be used not only by the approver to engage in transactions at a POS terminal. Rather, the purchaser may also request to use the payment accounts via a purchaser mobile wallet. In such a case, the approver payment account information is never stored permanently at the purchaser device, but rather the purchaser device acts as a conduit through which the approver payment account information (e.g., tokens) may be provided to the POS terminal.

The mobile wallet circuit 144 may be configured to process approver payment requests (or those from any other mobile wallet user). For example, the approver may select a payment account and bring the remote device 130 into a communication range of the merchant computing system 120. In response to receiving signal from the merchant computing system 120, the remote device 130 may transmit a token associated with the selected payment account and any other payment information or security information (e.g., a cryptogram, expiration date, verification number, etc.) to the merchant computing system 120, which may then transmit the token and the aforementioned described information to the mobile wallet computing system 140. The mobile wallet circuit 144 may receive this information and either de-tokenize the token or transmit the token to another entity for detokenization. Once the token is de-tokenized, the mobile wallet circuit 144 may identify the financial institution associated with the payment account and transmit the transaction information to the financial institution computing system 150, which may authorize the transaction request. In response to receiving an authorization from the financial institution computing system 150, the mobile wallet circuit 144 may transmit an authorization to the merchant over the network 170, which may enable the approver to complete the desired transaction. As will be appreciated, the role that the mobile wallet circuit 144 serves in mobile wallet transactions may vary depending on the implementation of the approver's mobile wallet. For example, in arrangements where the approver's mobile wallet operates under a host emulation framework, the mobile wallet circuit 144 may transmit approver payment information (e.g., tokens) to the remote device 130 to enable the approver to initiate a mobile wallet transaction. On the other hand, in arrangements where the mobile wallet is implemented in a secure element framework, the mobile wallet circuit 144 may not perform such functions.

In certain situations, a mobile wallet user may register for a mobile wallet account who possess no payment accounts with which to populate a mobile wallet. For example, the child of an account holder may wish to be able to conduct transactions using a parent's payment account via a wallet client application on the child's device. Alternatively, the mobile wallet user may possess payment accounts with which to conduct transactions, but wish to perform a particular transaction using a payment account of another user. For example, a friend of the approver may wish to make a purchase for the approver using the approver's payment account.

To address such situations, additional functionalities are included in the mobile wallet. In an example with the purchaser, the wallet client application 112 may present the purchaser with displays configured to receive a purchaser input to identify another mobile wallet user with which the purchaser is associated. Upon receipt of such an input from the purchaser device 110, the mobile wallet circuit 144 may identify an account associated with the identified mobile wallet user in the mobile wallet database 148 and populate the purchaser's mobile wallet with the identified user. Additionally, the mobile wallet circuit 144 may also request approval from the identified mobile wallet user. To illustrate, the purchaser may input the name of a parent (the approver) into the purchaser device 110, which may transmit the parent's name to the mobile wallet computing system 140. The mobile wallet circuit 144 may identify a mobile wallet account associated with the parent and transmit a notification (e.g., a push notification) to the remote device 130. The approver may interact with notification (e.g., press a portion of the I/O device 134) so as to activate the wallet client application 132, which may present the approver with a display configured to receive an approver input to accept the pairing of the child's mobile wallet to the parent's. Upon the parent's acceptance of the pairing, the mobile wallet circuit 144 may transmit a notification to the purchaser device 110. In response, the wallet client application 112 may populate the child's mobile wallet with an entry that enables the user to input a preference to contact the parent regarding a prospective transaction.

In some arrangements, upon the approver accepting the pairing of the purchaser's mobile wallet, the approver may set various restrictions on purchaser's ability to use the approver's account. For example, the approver may set up various spending limits for the purchaser's use of the account. To illustrate, the purchaser may set up a one-time purchase limit for the purchaser and the limit may be stored at the mobile wallet computing system 140. This way, if the purchaser sends a request to use the approver's mobile wallet for a transaction amount greater than the purchase limit, the mobile wallet computing system 140 may automatically deny the purchaser's request. Various other types of restrictions are envisioned. For example, the approver may set spending limits over varying time periods (e.g., daily, weekly, monthly, and the like). Additionally, the approver may set various preferences to automatically deny purchaser requests to purchase certain products, restrict the time at which the purchaser can make requests, and set location limits such that purchaser requests sent from particular locations are automatically denied.

In various embodiments, once two mobile wallets have been paired via the methods discussed above, the approver and the purchaser may wish to communicate with one another regarding a prospective transaction. In this regard, the mobile wallet computing system 140 further includes the data exchange circuit 146. The data exchange circuit 146 may perform a multi-step process to establish secure communications channels between the purchaser device 110 and the remote device 130. First, an input from the purchaser may be received from the purchaser device 110 over the network 170. The input may identify another mobile wallet user (e.g., the approver) as well as include a message identifying at least one aspect of a prospective purchaser transaction (e.g., a product description and/or image of the product).

In response to the receipt of such request, the data exchange circuit 146 may establish a real-time secure connection with the purchaser device 110. In an example, the data exchange circuit 146 may create a communication endpoint specifically for the purchaser device 110 including an IP address associated with the purchaser device 110 as well as a port number. The port number may be transmitted to the purchaser device 110 and the wallet client application 112 may configure the purchaser device 110 to incorporate the port number into any future messages transmitted by the purchaser device 110 to the mobile wallet computing system 140 so that the messages are directed to that particular endpoint. Any communication protocol may be used (e.g., the WebSocket protocol) and various encryption keys may be interchanged between the data exchange circuit 146 and the purchaser device 110 to enhance the security of the communications.

Additionally, the data exchange circuit 146 may identify the other mobile wallet user (the approver in this example) based on the received input from the purchaser and transmit a notification to the remote device 130. The approver may interact with the notification to activate the wallet client application 132, which may present the approver with the purchaser's message and establish a secure connection with the data exchange circuit 146 via a similar process to that discussed above with respect to the purchaser device 110. Once a secure connection with the remote device 130 is established, the date exchange circuit 146 may create a messaging hub between the purchaser device 110 and the remote device 130. The messaging hub basically creates a link between the port number associated with the purchaser device 110 and the port number associated with the remote device 130 such that, whenever a message is received from either of the purchaser device 110 or the remote device 130, that message is directed to the other device by way of the established secure channel. This way, a live messaging session is established to enable the approver and purchaser to securely communicate regarding a prospective transaction.

In some situations, in the messaging session, the approver may approve a prospective purchase and select a payment account to lend to the purchaser to complete the transaction. Such an action by the approver may cause an account-identifying signal to be transmitted to the mobile wallet computing system 140, which may identify the selected account and transmit a signal to the purchaser device 110 that causes the purchaser device 110 to present the purchaser with a representation of the selected account. In various embodiments, the representation is configured to receive a purchaser input to engage in the approved transaction. For example, the representation may include a graphical depiction of a credit card selected by the approver. The purchaser may select the depiction and, by so doing, cause the purchaser device 110 to perform a sequence to retrieve a set of payment credentials associated with the selected account. The particular sequence performed by the purchaser device 110 may vary depending on the implementation.

In a first implementation, a purchaser selection of the representation may cause the purchaser device 110 to transmit a payment credential request to the mobile wallet computing system 140. In response to the receipt of such a request, the data exchange circuit 146 transmits an instruction to the remote device 130. The instruction causes the remote device 130 to retrieve a payment credential (e.g., a payment token) associated with the selected payment account (e.g., from a system memory of the remote device 130, a secure element of the remote device 130, or from the mobile wallet computing system 140 or other card emulation service) and transmit that payment credential via the secure messaging channel to the data exchange circuit 146 and then the purchaser device 110. In various arrangements, the data exchange circuit 146 may package the credential with an additional instruction before transmitting the credential to the purchaser device 110. The instruction may cause the purchaser device 110 to temporarily maintain the payment credential in a data buffer of the purchaser device 110 for a predetermined period. As such, after the purchaser device 110 transmits the payment credential to the merchant computing system 120 (e.g., in response to a credential request received from the merchant computing system 120), the credential is deleted from the purchaser device 110. Thus, the systems and methods disclosed herein facilitate the temporary lending of payment credentials.

In another implementation, the purchaser's selection of the depiction of the payment account changes the way that the purchaser device 110 responds to receipt of a signal (e.g., an NFC signal) from the merchant computing system 120. Normally, upon receipt of a signal from the merchant computing system 120, the purchaser device 110 take steps to retrieve payment credentials that are associated with the purchaser's mobile wallet. For example, an NFC controller of the purchaser device 110 may interface with a secure element on the purchaser device 110 to retrieve payment credentials (e.g., a token) associated with a purchaser account to transmit to the merchant computing system 120.

However, after the purchaser interacts with the depiction of the selected payment account, the purchaser device 110 acts differently. Instead of retrieving credentials associated with the purchaser's mobile wallet, the purchaser device 110 relays information contained in a signal received from the merchant computing system 120 (e.g., a representation of a NFC signal) to the data exchange circuit 146 by the established secure channel, which in turn relays the information to the remote device 130. Upon receipt of the representation of the NFC signal, the wallet client application 132 of the remote device 130 causes the remote device 130 to retrieve payment credentials associated with the selected account. For example, the wallet client application 132 may cause a processor of the remote device 130 to retrieve payment credentials stored in a secure element of the remote device or any other system memory. Alternatively, the representation of the NFC signal may cause the remote device 130 to retrieve payment credentials stored elsewhere (e.g., at the mobile wallet computing system 140 or another host emulation service). Having retrieved the payment credentials, the remote device 130 transmits the payment credentials via the secure channel to the data exchange circuit 146 which in turn relays the credentials to the purchaser device 110. Upon receipt of the payment credentials, the purchaser device 110 temporarily maintains the credentials in a data buffer of the purchaser device 110 such that the payment credentials are transmitted to the merchant computing system 120 upon the receipt of another NFC signal from the merchant computing system 120.

It should be noted that other processes for sharing account credentials are envisioned. In some arrangements, for example, the process does not involve the real-time messaging channels discussed above. For example, the purchaser may send the initial message requesting approval from the approver well in advance of the anticipated time that the prospective transaction is to be completed (e.g., days in advance). In such instances, rather than establishing a real-time communications channel with the purchaser device 110 upon receipt of the purchaser's initial message, the data exchange circuit 146 may just direct the message to the remote device 110 along with a message notification. The approver may review the request any time thereafter and specify a time interval during which the purchaser may complete the transaction. The time-interval may be stored at the mobile wallet computing system 140 in association with the approver's account and relayed to the purchaser. As such, if the purchaser attempts to make the transaction outside of the specified time interval, the transaction will automatically be denied. If, however, the purchaser seeks to make the transaction (e.g., by pressing on the representation of the selected payment account) within the specified time interval, payment credentials may be transmitted to the purchaser device 110 via any of the methods discussed above.

As illustrated by the previous examples, the systems and methods disclosed herein enable the purchaser to make a purchase using the approver's payment account without the purchaser device 110 permanently storing payment credentials associated with the payment account. The only way that any payment credentials are even temporarily stored at the purchaser device 110 is if the approver approves a transaction proposed by the purchaser. This way, the approver has complete control over where payment credentials are stored and directed.

Still referring to FIG. 1, the purchaser device 110 is a computing device associated with a purchaser. In various embodiments, the purchaser is an individual seeking to make a purchase using an account not held or controlled by the individual and/or using information (e.g., payment credentials such as tokens account numbers, and the like) not stored in the purchaser device 110. In some arrangements, the account is held or controlled by an approver who is associated with the remote device 130, which may store the information necessary to make the purchase. Accordingly, in various arrangements, the purchaser uses the purchaser device 110 to communicate with the remote device 130 via the network 170.

The purchaser device 110 includes any type of computing device that may be used to conduct financial transactions. In this regard, the purchaser device 110 may include any wearable or non-wearable device. Wearable devices refer to any type of device that an individual wears including, but not limited to, a watch (e.g., smart watch), glasses (e.g., eye glasses, sunglasses, smart glasses, etc.), bracelet (e.g., a smart bracelet), etc. Purchaser device 110 may also include any type of mobile device including, but not limited to, a phone (e.g., smart phone, etc.), tablet, personal digital assistant, and/or computing devices (e.g., desktop computer, laptop computer, personal digital assistant, etc.).

In the example embodiment shown, the purchaser device 110 includes wallet client application 112, an input/output (“I/O”) device 114, and a network interface 116 enabling the purchaser device 110 to communicate data over the network 170. The I/O device 114 includes hardware and associated logics configured to enable the purchaser device 110 to exchange information with the purchaser and/or merchant computing system 120, as will be described in greater detail below. An input device or component of the I/O device 114 allows the purchaser to provide information to the purchaser device 110, and may include, for example, a mechanical keyboard, a touchscreen, a microphone, a camera, a fingerprint scanner, any user input device engageable with the purchaser device 110 via a USB, serial cable, Ethernet cable, and so on. An output device or component of the I/O device 114 allows the purchaser to receive information from the purchaser device 110, and may include, for example, a digital display, a speaker, illuminating icons, LEDs, and so on. The I/O device 114 may include systems, components, devices, and apparatuses that serve both input and output functions, allowing the merchant computing system 120 to exchange information with the purchaser device 110. Such systems, components, devices and apparatuses include, for example, radio frequency transceivers (e.g., RF or NFC-based transceivers) and other short range wireless transceivers (e.g., Bluetooth®, laser-based data transmitters, etc.).

The purchaser device 110 further includes a wallet client application 112. The wallet client application 112 is structured to facilitate and permit payments by interfacing with various accounts held by the purchaser and/or approver at various financial institutions. Accordingly, in some arrangements, wallet client application 112 is communicably coupled via the network interface 116 over the network 170 to the mobile wallet computing system 140. In some embodiments, the wallet client application 112 includes a circuit embodied within the purchaser device 110. For example, the wallet client application 112 may include program logic stored in a system memory of the purchaser device 110. In some embodiments, the wallet client application 112 is a web-based application, and many of the functionalities are provided at the mobile wallet computing system 140. As will be understood, the level of functionality that resides on the purchaser device 110 versus the mobile wallet computing system 140 will vary depending on the implementation.

In various arrangements, the wallet client application 112 is structured to permit mobile wallet users to engage in transactions through the initiation of communications with a merchant computing system 120. In this regard, the purchaser device 110 may include a near field communications (NFC) chip and an associated controller that configures the chip to exchange information with the merchant computing system 120 (e.g., via an NFC reader). The wallet client application 112 may interface with the NFC controller/chip in various ways depending on the implementation of the purchaser's mobile wallet and the circumstances of the transaction. In situations where the purchaser seeks to make a purchase using an account held by the purchaser or otherwise associated with the purchaser's mobile wallet, the NFC controller may not interface with the wallet client application 112. For example, in response to receiving a signal from the merchant computing system 120, the NFC controller may retrieve payment credentials associated with a purchaser account from a secure element of the purchaser device 110. Alternatively, in other arrangements, the NFC controller may interface with the wallet client application 112 to retrieve payment credentials associated with a purchaser's account (e.g., if the mobile wallet is implemented using a host emulation framework).

Further, as alluded to above, if the purchaser seeks to make a purchase using payment credentials that not associated with the purchaser's mobile wallet, the NFC controller may produce a representation of the NFC signal received from the merchant computing system 120 and transmit the representation to the mobile wallet computing system 140. Additionally, in response to receiving payment credentials from the remote device 130, the wallet client application 112 may configure the NFC controller to temporarily store the payment credentials and transmit the payment credentials upon receipt of another signal from the merchant computing system 120.

In some arrangements, the wallet client application 112 is structured to enable the purchaser to manage a mobile wallet. In this regard, the wallet client application 112 is structured to present, control, and otherwise manage displays or graphical user interfaces on the purchaser device 110 including information pertaining to purchaser payment accounts and/or other mobile wallet users (e.g., the approver). For example, the wallet client application 112 may present the purchaser with displays enabling the user to input information pertaining to various payment accounts held by the purchaser. The screens may enable the user to manually input information (e.g., a PAN) pertaining to a payment account, or enable the user to take a picture of a payment card. The wallet client application 112 may then process the information input by the purchaser, identify account information, and transmit the information to the mobile wallet computing system 140 for storage (e.g., in the mobile wallet database 148 in association with the purchaser). Once information pertaining to various payment accounts has been received by the mobile wallet computing system 140, the wallet client application 112 is configured to present displays that enable the user to select a payment accounts and use the selected account to perform a transaction by interfacing with the merchant computing system 120.

Additionally, as discussed above, the displays presented by the wallet client application 112 may further enable the purchaser to input information pertaining to various other mobile wallet users with which the purchaser would like to associate with. As discussed above, such inputs may be transmitted to the mobile wallet computing system 140 for storage in association with the purchaser's mobile wallet account. Further, the wallet client application 112 may include a messaging feature enabling the purchaser to interface with the data exchange circuit 146 discussed above to communicate with the approver in real-time regarding a prospective transaction.

The remote device 130 is a computing device associated with the approver. The approver may be any type of entity (e.g., individual, association, organization, or the like) capable possessing a mobile wallet account and associated payment account at the financial institution associated with the financial institution computing system 150. In the example shown, similar to the purchaser device 110, the remote device 130 includes a network interface 136 enabling the remote device 130 to communicate data over the network 170, an I/O device 134, and a wallet client application 132. In various embodiments, the remote device 130 is capable of performing similar operations to the purchaser device 110 discussed above.

Regarding the wallet client application 132, the wallet client application 132 has similar structures and performs similar functions as the wallet client application 112 of the purchaser device 110. In this respect, the wallet client application 132 configures the remote device 130 to act in concert with the purchaser 110 to facilitate the purchaser making a purchase using a payment account associated with the approver.

The merchant computing system 120 is a computing system associated with a merchant. In accordance with the embodiments described herein, the merchant may include any type of entity with which a user (e.g., the purchaser) may engage in any type of transaction. In the example shown, the merchant may be a brick-and-mortar store. In other arrangements, the merchant may be another individual, and the merchant computing system 120 may be similar in nature to the purchaser device 110 discussed above.

In the example embodiment shown, the merchant computing system 120 includes a network interface 128 enabling the merchant computing system 120 to exchange data over the network 170, an I/O device 126, a transaction circuit 124, and a product database 122. The I/O device 126 includes hardware and associated logics configured to enable the merchant computing system 120 to exchange information with personnel associated with the merchant as well as the purchaser device 110 via hardware similar to that discussed above in relation to the purchaser device 110. In various embodiments, the I/O device 126 includes a wireless communication device (e.g., an NFC reader) that is configured to transmit wireless signals that are specifically formatted to induce a particular response in the purchaser device 110. For example, in response to receiving the wireless signal transmitted by the I/O device 126, the purchaser device 110 may retrieve a payment credential (e.g., a token) by any of the methods described herein and transmit a signal including the token back to the merchant computing system 120. Additionally, the I/O device 126 may further include additional components, such as a scanner that is configured to scan various codes associated with various products offered by the merchant.

The product database 122 is structured to retrievably store information pertaining to various products offered by the merchant. The product database 122 may include non-transient data storage mediums (e.g., local disc or flash-based hard drives, local network servers, and the like) or remote data storage facilities (e.g., cloud servers). In various embodiments, the information stored at the product database 122 may include product pricing information. Additionally, the product database may include various product descriptions and/or images of various products offered by the merchant. The product database 122 may include various entries, with each entry being associated with a different product. Each entry may include a product code associated with a particular product, a product price, a description of the product, as well as an image of the product.

The transaction circuit 124 is structured to facilitate the performance of various transactions. In this regard, the transaction circuit 124 is configured to formulate a payment request using various forms of information received during various steps of a transaction process. For example, the purchaser may approach the merchant computing system 120 with a product including a barcode affixed thereto. An attendant may scan the barcode using a scanner included in the I/O device 126 to identify a product code associated with the product. The transaction circuit 124 may then retrieve a product price stored in association with the product code in the product database 122. Further, the purchaser may cause the purchaser device 110 to transmit payment credentials obtained via the methods described herein to the merchant computing system 120, and the transaction circuit 124 may package the payment credentials with the product price into a payment request which may be transmitted to the mobile wallet computing system 140 over the network 170. Additionally, the transaction circuit 124 may receive a notification that the payment was approved (e.g., by the financial institution computing system 150) and transmit a notification of the payment to both the purchaser device 110 and the remote device 130.

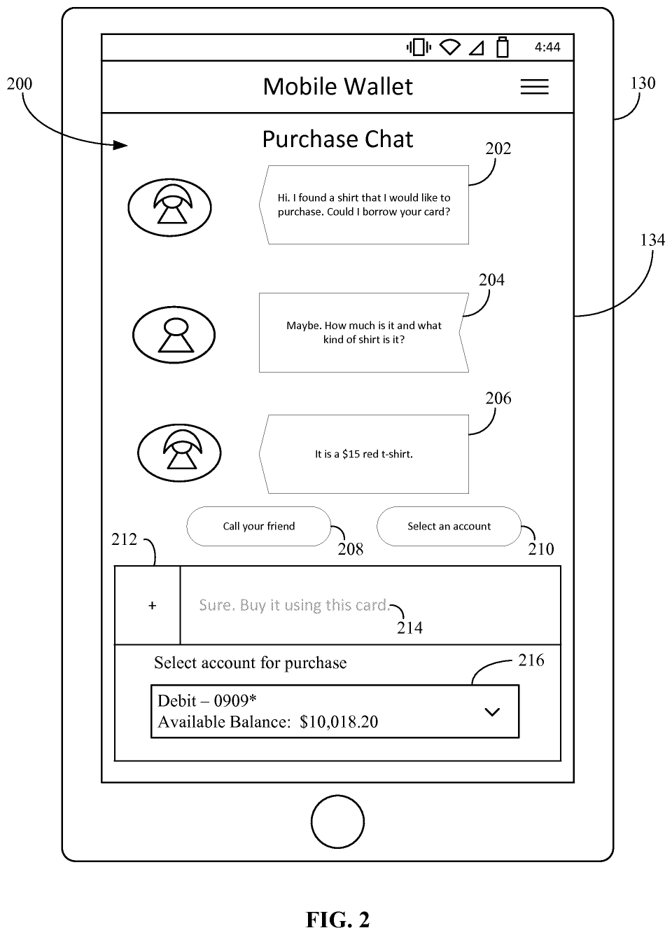

Turning now to FIG. 2, a messaging interface 200 is shown, according to an example embodiment. In various embodiments, interfaces such as the interface 200 may be displayed on the remote device 130 via the wallet client application 132. As shown, the interface 200 includes a first message 202, a second message 204, and a third message 206. The first message 202 may have been input by the purchaser into the purchaser device 110. For example, the purchaser may enter a merchant and see a product to purchase. The purchaser may then activate the wallet client application 112 on the purchaser device 110, select the approver from a list of mobile wallet users, input the message 202 into the purchaser device 110 via the I/O device 114, and send the message 202 to the mobile wallet computing system 140. Upon receipt of the message, the mobile wallet computing system 140 may identify the remote device 130 associated with the approver and transmit the message 202 to the remote device 130 in the form of a notification. In turn, the approver may activate the wallet client application 132 to establish a secure connection with the mobile wallet computing system 140 and input the message 204 requesting further information and hit the transmit button 212 to direct the message 204 to the purchaser device 110 via the data exchange circuit 146. In response, the purchaser may input the message 206 providing the requested information.

Upon receipt of the message 206, the approver may initiate a phone call with the purchaser by pressing the call button 208. Alternatively, the approver may input an additional message 214 and/or approve the transaction by pressing the account selection button 210 and selecting a payment account to lend to the purchaser. In some arrangements, upon hitting the account selection button 210, the interface is updated to include an account selection window 216 that lists all of the accounts that have been provisioned to the approver's mobile wallet.

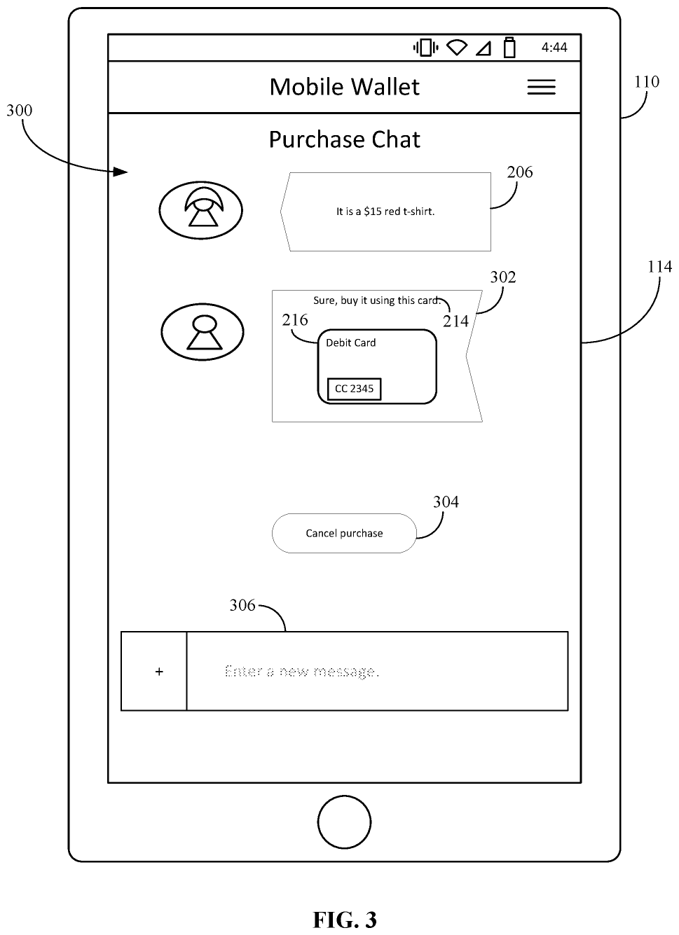

Turning now to FIG. 3, another messaging interface 300 is shown, according to an example embodiment. Interfaces such as the interface 300 may be presented on the purchaser device 110 via the I/O device 114 after the approver approves a purchase and selects a payment account to lend to the purchaser. As shown, the interface 300 includes the third message 206 and an additional message window 302. The additional message window 302 includes an additional message 214 input by the approver as well as a depiction 216 of the payment account selected by the approver to lend to the purchaser to make the purchase. In various embodiments, by selecting the depiction 216 (e.g., by pressing a portion of a touchscreen of the purchaser device 110) the purchaser can provide an input to program logic included in the wallet client application 112 being executed by a processor of the purchaser device 110. As discussed above, in response to such an input, purchaser device 110 may perform several operations to enable the purchaser device 110 to receive the payment credentials associated with the depicted payment account from the remote device 130 to enable the purchaser to pay for the proposed transaction.

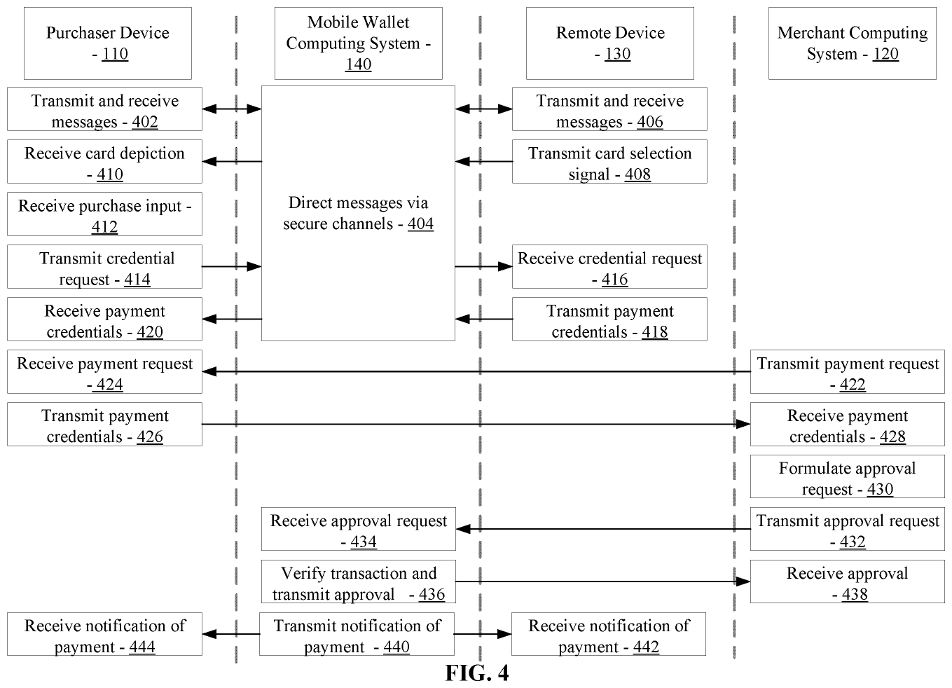

Turning now to FIG. 4, a method 400 of making a payment is shown, according to an example embodiment. In various embodiments, the method 400 may be performed by the components of FIG. 1 such that reference to the components of FIG. 1 may be made to aid the description of the method 400. For example, the method 400 may be performed by the purchaser and remote devices 110 and 130 (e.g., via wallet client applications 112 and 132), the mobile wallet computing system 140 (e.g., via the mobile wallet circuit 144 and data exchange circuit 146), the merchant computing system 120 (e.g., via the transaction circuit 124), and the financial institution computing system 150 (e.g., via the payment processing circuit 154).

At 402, 404, and 406, the purchaser and the approver communicate regarding a transaction via secure communication channels established by the mobile wallet computing system 140 (e.g., established by the data exchange circuit 146). In one example, the purchaser may be at a merchant and find a product to purchase using an account held by the approver. At 402, the purchaser may activate the wallet client application 112 on the purchaser device 110, input the name of the approver, and input details regarding the product. The details may include, for example, a description of the product or an image of the product, and a merchant at which the product is to be purchased. Alternatively or additionally, the purchaser may take an image of a barcode associated with the product. Upon the purchaser entering the product details, the purchaser device 110 may transmit a product message to the mobile wallet computing system 140.

In some arrangements, the wallet client application 112 may cause the purchaser device 110 to package additional information into the product message. For example, the wallet client application 112 may cause a processor of the purchaser device 110 to package information generated by a location sensing device (e.g., a GPS locator) into the product message.

Upon receipt of the product message, the mobile wallet computing system 140 (e.g., via the data exchange circuit 146) may establish a secure communication channel with the purchaser device 110 and identify the approver. Additionally, the mobile wallet computing system 140 (e.g., via the mobile wallet circuit 144) may formulate a transaction notification based on the details input by the purchaser. For example, if the product message includes an image of a barcode, the mobile wallet circuit 144 may, for example, identify the merchant based on the purchaser-input details and identify a product code associated with the product based on the image of the barcode. Based on the merchant and the product code, the mobile wallet circuit 144 may retrieve SKU-level product details from a transaction database (not shown) and package those details into a transaction notification template for transmittal to the remote device 130. Alternatively or additionally, the identity of the merchant at which the purchaser is located may be identified based on purchaser location information contained in the product message. For example, the mobile wallet computing system 140 may have a plurality of merchant locations stored thereon, and the mobile wallet circuit 144 may run a comparison of the purchaser's current location to those various locations and identify the purchaser as being located at a particular merchant if the purchaser's current location is within a predetermined distance threshold of one of the merchant locations.

In some embodiments, upon receipt of the product message, the mobile wallet computing system 140 (e.g., via the mobile wallet circuit 144) may perform various checks on the product message prior to relaying the message to the remote device 130. For example, various product details retrieved and/or contained in the message may be cross-referenced against a set of restrictions set by the approver. As discussed above, the approver may set various restrictions (e.g., location limits, time limits, spending limits, and the like) on the purchaser's ability to request approval from the approver. Accordingly, upon identifying the approver, restrictions set by the approver may be retrieved from the mobile wallet database 148 and used to assess the received product message. If the purchaser's location is not compatible with a location preference set by the approver, for example, an automatic denial of the approval request may be relayed back to the purchaser device 110 and the method 400 may end.

The remote device 130 may receive the notification and present an alert to the approver in the form of the push notification at 406. For example, the alert may be presented to the approver on a main screen of the remote device 130. The approver may interact with the notification and, by so doing, activate the wallet client application 132 on the remote device 130, which may cause the remote device 130 to transmit a signal to the mobile wallet computing system 140 causing the mobile wallet computing system 140 (e.g., by the data exchange circuit 146) to establish a secure communication channel with the remote device 130. Additionally, the wallet client application 132 may present the approver with a display describing the transaction proposed by the purchaser. For example, the display may include a message initially input by the purchaser as well as various SKU product details retrieved by the mobile wallet computing system 140. At this point, additional messages may be exchanged between the purchaser and the approver similar to those discussed above in relation to FIG. 2-3.

At 408, the remote device 130 transmits a card selection signal to the mobile wallet computing system 140 via the secure channel created above. For example, the approver may decide to allow the purchaser to conduct the proposed transaction using a particular payment account. Thus, the approver may provide an input to select a payment account. For example, the approver may select (e.g., via a graphical interface presented to the approver on the I/O device 134) an account that was issued by the financial institution associated with the financial institution computing system 150. Upon receiving this input, the wallet client application 132 may cause the remote device 130 may transmit an account identifying notification to the mobile wallet computing system 140 at 408. The account identifying notification may include, for example, a portion of a PAN or the like or any other identifier that is unique to the selected payment account. In response to the account identifying signal, the mobile wallet computing system 140 (e.g., via the data exchange circuit 146) may transmit a signal to the purchaser device 110. In some arrangements, the signal is encoded with information regarding the payment account selected by the approver. In some embodiments, responsive to the account identifying signal, the mobile wallet circuit 144 retrieves information regarding the selected payment account from the mobile wallet database 148 (e.g., a portion of an account number, a name for the credential created by the approver, etc.), and uses the retrieved information to generate the signal that is transmitted to the purchaser device 110.

The purchaser device 110 receives the signal at 410. The signal may cause the purchaser device 110 to present the purchaser with a depiction (e.g., via the wallet client application 112) of the selected payment account via the I/O device 114. In some arrangements, the depiction is generic across payment accounts and is a basic representation of the selected payment account (e.g., a blank outline of a payment card). In other arrangements, the depiction includes an aspect that identifies the payment account that was selected by the approver. For example, the depiction may include a descriptor that identifies the type of account selected by the approver or a portion of an account number.

At 412, a purchase input is received. For example, the purchaser may interact (e.g., via the I/O device 114) with the depiction of the selected payment account to provide such an input to the purchaser device 110. In various embodiments, in response to the input, the wallet client application 112 causes the purchaser device 110 to transmit a credential request signal at 414 via the network interface 116 to the mobile wallet computing system 140, which relays the credential request to the remote device 130, where the credential request is received at 416.

In response to receiving the credential request, the remote device 130 transmits payment credentials at 418. Upon receipt of the signal indicating that the purchaser is ready to complete the transaction, the wallet client application 132 may cause the remote device 130 to retrieve payment credentials associated with the selected account. In some embodiments, for example, the wallet client application 132 may cause a processor of the remote device 130 to retrieve the payment credentials (e.g., a token or the like) from a secure element of the remote device 130. In some embodiments, the credentials may be retrieved from within another system memory of the remote device 130. In some embodiments, the credentials may be retrieved from an external computing system, such as a host emulation service or the mobile wallet computing system 140. In any event, once the credentials are retrieved, the credentials are transmitted at 418 by way of the secure channel to be received by the purchaser device 110 at 420. Upon receipt of the payment credentials, the wallet client application 112 of the purchaser device 110 temporarily maintains the credentials in a data buffer of the purchaser device 110 such that the credentials are not permanently stored on the purchaser device 110. Additionally, the credentials are stored such that they are only transmitted by the purchaser device 110 in predefined circumstances via predetermined protocols (e.g., in response to receiving a specifically formatted wireless signal from the merchant computing system 120).

At 422 and 424, the purchaser device 110 receives a payment request transmitted by the merchant computing system 120. For example, at the merchant, the purchaser may approach the merchant computing system 120 with a product. The product may have a barcode or the like affixed thereto. In various embodiments, the purchaser may hand the product to an attendant proximate to the merchant computing system 120, and the attendant may scan the affixed barcode (e.g., via a scanner included in the I/O device 126). Upon the scanning of the barcode, the merchant computing system 120 (e.g., via the transaction circuit 124) may identify a product code associated with the product and retrieve product information stored in association with that code (e.g., product pricing information, a product description, a product image, and the like) from the product database 122. Such information may be used to request payment from the purchaser. For example, a display included in the I/O device 126 may present the purchaser with the retrieved product price. In response, the purchaser may bring the purchaser device 110 in close proximity to, for example, an NFC reader included in the merchant computing system 120. The NFC reader may emit a signal containing an automatic data processing unit (ADPU) including an application identifier (AID) associated with the wallet client application 112. Upon the purchaser device 110 receiving the emitted signal, the purchaser device 110 retrieves the credentials from the data buffer and transmits the credentials at 426. The credentials are received by the merchant computing system 120 at 428.

Upon receipt of the payment credentials, the merchant computing system 120 formulates an approval request at 430. The approval request may include both the received payment credentials as well as a payment amount. In various embodiments, the payment amount may closely correspond to the product price previously retrieved by the transaction circuit 124. In some embodiments, the approval request may also include a description of the product retrieved from the product database 122. Thus, upon packaging the received payment credentials with the payment amount and any other information, the transaction circuit 124 may transmit an approval request to the mobile wallet computing system 440 at 432.

The mobile wallet computing system 140 receives the approval request at 434. The specific actions that the mobile wallet computing system 140 takes in response will vary depending on the arrangement. In some embodiments, the mobile wallet computing system 140 is associated with the financial institution computing system 150, which issued the payment account selected by the approver. In such embodiments, upon the receipt of the payment credentials at 434, the mobile wallet computing system 140 may perform a process to verify the transaction at 436. In such a process, the mobile wallet circuit 144 may first de-tokenize the received payment credentials (e.g., by transmitting the payment credentials to a card network computing system or via a token vault maintained at the mobile wallet computing system 140). Upon detokenizing the payment credentials, the mobile wallet circuit 144 may identify the selected payment account, perform various checks on the selected account (e.g., account balance checks) to determine if payment for the requested amount may be deducted from the selected account.

As will be appreciated, in arrangements where the mobile wallet computing system 140 is not associated with the financial institution computing system 150, the payment credentials may be transmitted to external computing systems (e.g., a card network computing system and/or the financial institution computing system 150) for detokenization and verification. To illustrate, in one embodiment, the mobile wallet computing system 140 may transmit information regarding the transaction to the financial institution computing system 150. The transmitted information may include a transaction amount and the identity of the approver's selected payment account, for example. Using such information, the financial institution computing system 150 may perform verification checks (e.g., determining whether there are sufficient funds in the approver's account), approve the transaction, transmit a notification back to the mobile wallet computing system 140 upon approval. In response to receiving the notification, the mobile wallet computing system 140 may provide notifications of the payment to the purchaser device 110 and the remote device 130.

Further, in some embodiments, the mobile wallet computing system 140 may perform additional operations to verify that the transaction described by the approval request matches the transaction initially approved by the approver at 436. In this regard, the mobile wallet circuit 144 may compare the information describing the prospective transaction in a message sent by the purchaser to the approver during steps 402, 404, and 406 with information contained in the approval request. As discussed above, the purchaser may include an image of a product code or the like the message transmitted at 402 and, in response to receiving such a message, the mobile wallet computing system 140 may retrieve various product details (e.g., a price) from a database based on the product code. Accordingly, the mobile wallet circuit 144 may compare the payment amount (or other attributes) included in the approval request received from the merchant computing system 120 to those retrieved in response to the purchaser's message. If the prices match (or are within a predetermined threshold of one another), then the transaction may be verified, and an approval of the payment request is transmitted to the merchant computing system 120 at 436. Upon receipt of the approval at 438, the merchant may deduct the payment for the transaction from the approver's selected account, thereby enabling the purchaser to complete the transaction.

Alternatively or additionally, another approval message may be transmitted to the remote device 130 after the mobile wallet computing system 140 receives the payment request at 434. The approval message may include the information contained in the payment request received from the merchant computing system 120 (e.g., a payment amount, a product description, and the like), and enable the approver to provide an input to verify that the transaction is approved.

After transmitting the approval to the merchant computing system 120 at 436 and 438, the mobile wallet computing system 140 transmits notifications of the transaction's completion to the purchaser device 110 and the remote device 130 at 440. In some embodiments, the notifications are transmitted via the secure channels established between the mobile wallet computing system 140 and the purchaser device 110 and remote device 130 at steps 402, 404, and 406. In such arrangements, upon receipt of the notifications by the purchaser and remote devices 110 and 130 at 442 and 444, the notifications show up as additional messages in the chat session between the approver and the purchaser. Alternatively or additionally, the notifications may be transmitted in the form of push notifications that show up on main screens of the purchaser and remote devices 110 and 130. In any event, the notification may identify the merchant at which the transaction was completed and identify the amount of the transaction. In some embodiments, the notification may also identify the product that was purchased.

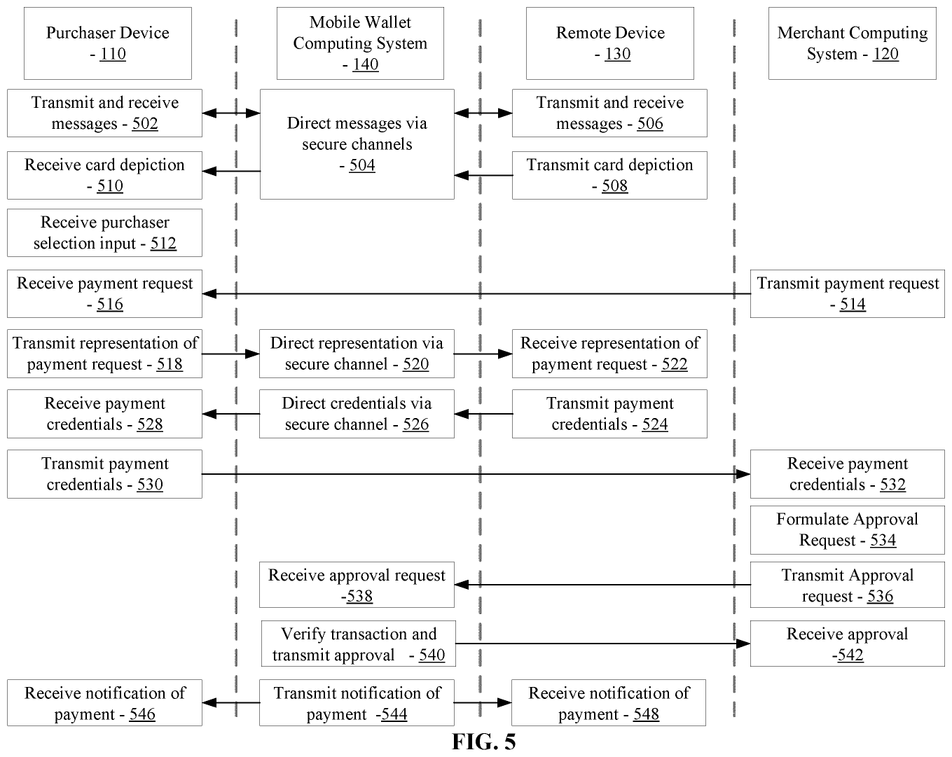

Turning now to FIG. 5, an alternative method 500 of making a payment is shown, according to an example embodiment. In various embodiments, the method 500 may be performed by the components of FIG. 1 such that reference to the components of FIG. 1 may be made to aid the description of the method 500. For example, the method 500 may be performed by the purchaser and remote devices 110 and 130 (e.g., via wallet client applications 112 and 132), the mobile wallet computing system 140 (e.g., via the mobile wallet circuit 144 and data exchange circuit 146), the merchant computing system 120 (e.g., via the transaction circuit 124), and the financial institution computing system 150 (e.g., via the payment processing circuit 154).

In various embodiments, the method 500 serves as an alternative to the method 400 discussed above in relation to FIG. 4. As such, many of the steps of the method 500 are substantially similar to those of the method 400, except in one crucial respect. More specifically, the method 500 mainly differs from the method 400 in timing and methodologies through which the purchaser device 110 receives and transmits payment credentials associated with a payment account selected by the approver. Accordingly, steps 502-512 of the method 500 are similar or substantially similar to the steps 402-412 of the method 400.

The method 500 starts to differ from the method 400 once the purchaser selects the depiction of the payment account selected by the approver. Recall that, in the method 400, after the purchaser selects the depiction of the payment account selected by the approver, the remote device 130 transmits payment credentials associated with the selected account to the purchaser device 110 prior to the purchaser initiating communications with the merchant computing system 120. In the method 500, however, the purchaser's selection of the depiction causes the processor of the purchaser device 110 to perform an alternative set operations. Rather than transmitting a request for payment credentials to the remote device 130 by way of the mobile wallet computing system 140 as in the method 400, the purchaser's selection of the depiction causes the processor of the purchaser device 110 to place the NFC controller of the purchaser device 110 into the conduit mode discussed above. When in such a mode, the NFC controller responds differently to a signal received from the merchant computing system 120 than when the controller is operating normally. When in normal mode, the NFC controller may interface with a secure element or the wallet client application 112 to retrieve payment credentials associated with an account that has been provisioned to the purchaser's mobile wallet. In conduit mode, however, the NFC controller is structured to generate a representation of the NFC signal received from the merchant computing system 120 and to cause that representation to be transmitted to the remote device 130 by way of the mobile wallet computing system 140.

Accordingly, after the purchaser selection input is received at 512, a processor of the purchaser device 110 places the NFC controller of the purchaser device into conduit mode, and the purchaser brings the purchaser device 110 within a communication range of, for example, an NFC reader at the merchant computing system 120. The NFC reader transmits an NFC signal at 514 that is received by the purchaser device 110 at 516. Upon receipt of the signal by an NFC chip on the purchaser device 110, an associated NFC controller provides an input to the wallet client application 112, which causes the processor of the purchaser device 110 to generate a representation of the received NFC signal and transmit the representation to the remote device 130 by way of the secure communication channel established by the mobile wallet computing system 140. In some embodiments, the generation of the representation of the NFC signal includes incorporating account identifying information of the account selected by the approver. The mobile wallet computing system 140 receives the representation signal and directs it to the remote device 130 at 520.

At 522, the remote device 130 receives the representation of the signal initially generated at the merchant computing system 120. In various arrangements, the representation may be specifically formatted to induce the remote device 110 to behave as if the representation was an NFC control signal. In other words, even though the representation is received via the network 170 by way of the network interface 136, the wallet client application 132 causes the processor of the remote device 130 to behave as if the remote device 130 received the signal emitted by the merchant computing system 120 that was received by the purchaser device 110 at 516. As such, upon receipt of the representation, the wallet client application 132 causes the processor of the remote device 130 to retrieve payment credentials associated with the selected account by any of the means disclosed herein and transmit those credentials by way of the network interface 136 to the mobile wallet computing system 140 at 524, where the credentials are received at 526 and directed to the purchaser device 110 via the data exchange circuit 146.

The purchaser device 110 receives the credentials at 528. Upon receipt of the payment credentials, the wallet client application 112 causes the processor of the purchaser device 110 to temporarily maintain the credentials in a data buffer of the purchaser device 110 such that the credentials are not permanently stored on the purchaser device 110. Additionally, the credentials are stored such that they are only transmitted by the purchaser device 110 in predefined circumstances via predetermined protocols. After the payment credentials are received, the purchaser may again bring the purchaser device 110 within a communication range of the merchant computing system 120, and again cause the purchaser device 110 to receive an NFC signal containing an ADPU that causes the temporarily stored payment credentials to be transmitted to the merchant computing system 120 at 530. After the payment credentials are transmitted, they are removed from the data buffer of the purchaser device 110.

After the payment credentials are transmitted, the method includes various steps 532, 534, 536, 538, 540, 542, 544, 546, and 548 that are similar or substantially similar to steps 428, 430, 432, 434, 436, 438, 440, 442, and 444 of the method 400 discussed above in relation to FIG. 4. Thus, as described with respect to FIG. 4, the mobile wallet computing system 140 may communicate with the financial institution computing system 150 to receive approval for processing the payment for the mobile wallet transaction.

Thus using either the method 400 or the method 500 the purchaser is able to securely complete a transaction using the approver's account without any payment credentials associated with the approver's account being permanently stored on the purchaser device 110. As such, the approver is able to share an account with other mobile wallet users but maintain control over where payment credentials are stored.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U. S. C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A computer-implemented method, comprising:
receiving, by a mobile wallet computing system, an approval request for a prospective mobile wallet transaction from a first device associated with a purchaser, the approval request identifying an approver and a port value associated with a communication endpoint of the first device, wherein the approval request includes characteristic of the prospective mobile wallet transaction;
transmitting, by the mobile wallet computing system, a transaction notification to a second device associated with the approver, the transaction notification including the characteristic of the prospective transaction;
receiving, by the mobile wallet computing system, an approval input from the second device, the approval input identifying a payment account of the approver that is not provisioned to the purchaser's mobile wallet, and further identifying a port value associated with a communication endpoint of the second device;
establishing, by the mobile wallet computing system, a communication channel that links the communication endpoint of the first device to the communication endpoint of the second device based on the port values associated with the communication endpoints of the first and second devices such that the purchaser and the approver can exchange messages regarding the prospective mobile wallet transaction via the communication channel;
generating, by the mobile wallet computing system, a payment token for the first device in response to receiving the approval input, the payment token associated with the payment account and configured to delete from the first device after transmission of the payment token from the first device; and
transmitting, by the mobile wallet computing system, the payment token to the first device which provides the payment token to a point of sale device.

2. The method of claim 1, further comprising:
receiving, by the mobile wallet computing system, a payment approval request for the prospective mobile wallet transaction from a merchant computing system associated with a merchant, the payment approval request including the payment token and a payment amount;
identifying, by mobile wallet computing system, the payment account based on the payment token included in the payment approval request; and
authorizing, by the mobile wallet computing system, the payment amount as part of the prospective mobile wallet transaction.

3. The method of claim 2, wherein the prospective mobile wallet transaction includes a purchase of a product at the merchant, wherein the approval request includes a product code associated with the product or a representation of a product code, wherein the method further comprises:
retrieving, by the mobile wallet computing system, a product price from a database based on the product code or representation thereof responsive to receiving the approval request; and
verifying, by the mobile wallet computing system, that the product price included in the payment approval request matches the product price retrieved from the database, wherein the authorization of the deduction of the payment amount is responsive to the verification.

4. The method of claim 1, further comprising:
receiving, by the mobile wallet computing system, a request to conduct the prospective mobile wallet transaction from the first device;
transmitting, by the mobile wallet computing system, a request for payment credentials to the second device in response to receiving the request to conduct the prospective mobile wallet transaction; and
receiving, by the mobile wallet computing system, a set of payment credentials from the second device prior to transmitting the payment token to the first device.

5. The method of claim 1, further comprising:
receiving, by the mobile wallet computing system, from the first device, a representation of a request for payment credentials generated by a merchant computing system associated with a merchant;
transmitting, by the mobile wallet computing system, the representation to the second device; and
receiving, by the mobile wallet computing system, a set of payment credentials from the second device prior to transmitting the payment token to the first device.

6. The method of claim 1, further comprising identifying, by the mobile wallet computing system, the second device within a mobile wallet database based on information contained in the approval request.

7. (canceled)

8. The method of claim 1, further comprising transmitting, by the mobile wallet computing system, an indication of the approval input to the first device, the indication of the approval input being configured to present the purchaser with a depiction of the payment account.

9. A mobile wallet computing system, comprising:
a network interface configured to communicate data over a network;
a mobile wallet database configured to store information regarding a first mobile wallet account associated with a purchaser and a second mobile wallet account associated with an approver; and
a processing circuit configured to:
receive, by the network interface, an approval request for a prospective mobile wallet transaction from a first device associated with the purchaser, the approval request identifying the approver and a port value associated with a communication endpoint of the first device wherein the approval request includes a characteristic of the prospective mobile wallet transaction;
transmit, by the network interface, a transaction notification to a second device associated with the approver, the transaction notification including the characteristic of the prospective transaction;
receive, by the network interface, an approval input from the second device, the approval input identifying a payment account of the approver that is not provisioned to the first mobile wallet account, and further identifying a port value associated with a communication endpoint of the second device;
establish a communication channel that links the communication endpoint of the first device to the communication endpoint of the second device based on the port values associated with the communication endpoints of the first and second devices such that the purchaser and the approver can exchange messages regarding the prospective mobile wallet transaction via the communication channel;
generate a payment token for the first device in response to receiving the approval input, the payment token associated with the payment account and configured to delete from the first device after transmission of the payment token from the first device; and
transmit, by the network interface, the payment token to the first device which provides the payment token to a point of sale device.

10. The mobile wallet computing system of claim 9, wherein the processing circuit is further configured to:
receive, by the network interface, a payment approval request for the mobile wallet transaction from a merchant computing system associated with a merchant, the payment approval request including the payment token and a payment amount;
identify the payment account based on the payment token included in the payment approval request; and
authorizing the payment amount to be deducted from the identified payment account.

11. The mobile wallet computing system of claim 10, wherein the prospective mobile wallet transaction includes a purchase of a product at the merchant, wherein the approval request includes a product code associated with the product or a representation of a product code, wherein the processing circuit is further configured to:
retrieve a product price from a database based on the product code or representation thereof responsive to receiving the approval request; and
verify that the product price included in the payment approval request matches the product price retrieved from the database, wherein the authorization of the deduction of the payment amount is responsive to the verification.

12. The mobile wallet computing system of claim 9, wherein the processing circuit is further configured to:
receive, by the network interface, a purchasing input from the purchaser device indicating a preference of the purchaser to engage in the prospective mobile wallet transaction;
transmit, by the network interface, a request for payment credentials to the second device upon receipt of the purchasing input; and
receive, by the network interface a set of payment credentials from the second device prior to transmitting the payment token to the first device.

13. The mobile wallet computing system of claim 10, wherein the processing circuit is further configured to:
receive, by the network interface, from the first device, a representation of a request for payment credentials generated by a merchant computing system associated with a merchant;
transmit, by the network interface, the representation to the second device;
receive, by the network interface, a set of payment credentials from the second device prior to transmitting the payment token to the first device.

14. The mobile wallet computing system of claim 9, wherein the processing circuit is further configured to identify the second device within the mobile wallet database based on information contained in the approval request.

15. (canceled)

16. The mobile wallet computing system of claim 9, further comprising transmitting, by the network interface, an indication of the approval input to the first device, the indication of the approval input being configured to present the purchaser with a depiction of the payment account.

17. A non-transitory computer readable media having computer-executable instructions embodied therein that, when executed by a processor of a mobile wallet computing system, cause the mobile wallet computing system to perform operations to enable a payment, the operations comprising:
receiving an approval request for a prospective mobile wallet transaction from a first device associated with a purchaser, the approval request identifying an approver and a port value associated with a communication endpoint of the first device, wherein the approval request includes a characteristic of the prospective mobile wallet transaction;
transmitting a transaction notification to a second device associated with the approver, the transaction notification including the characteristic of the prospective transaction;
receiving an approval input from the second device, the approval input identifying a payment account of the approver that is not provisioned to the purchaser's mobile wallet, and further identifying a port value associated with a communication endpoint of the second device;
establishing a communication channel that links the communication endpoint of the first device to the communication endpoint of the second device based on the port values associated with the communication endpoints of the first and second devices such that the purchaser and the approver can exchange messages regarding the prospective mobile wallet transaction via the communication channel;
generating a payment token for the first device in response to receiving the approval input, the payment token associated with the payment account and configured to delete from the first device after transmission of the payment token from the first device; and
transmitting the payment token to the first device which provides the payment token to a point of sale device.

18. The media of claim 17, the operations further comprising:
receiving a payment approval request for the prospective mobile wallet transaction from a merchant computing system associated with a merchant, the payment approval request including the payment token and a payment amount;
identifying the payment account based on the payment token included in the payment approval request; and
authorizing the payment amount to be deducted from the identified payment account.

19. The media of claim 17, the operations further comprising:
receiving a request to conduct the prospective mobile wallet transaction from the first device;
transmitting a request for payment credentials to the second device in response to receiving the request to conduct the prospective mobile wallet transaction;
receiving a set of payment credentials from the second device prior to transmitting the payment token to the first device.

20. The media of claim 19, the operations further comprising:
receiving, from the first device, a representation of a request for payment credentials generated by a merchant computing system associated with a merchant;
transmitting the representation to the second device;
receiving a set of payment credentials from the second device, prior to transmitting the payment token to the first device.
